(19) United States
(12) Patent Application Publication
(10) Pub. No.: US 2015/0348488 A1
(43) Pub. Date: Dec. 3, 2015

(54) GAMMA REFERENCE VOLTAGE GENERATING CIRCUIT, ARRAY SUBSTRATE AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventor: Xingji WU, Beijing (CN)

(21) Appl. No.: 14/573,690

(22) Filed: Dec. 17, 2014

(30) Foreign Application Priority Data
Jun. 3, 2014 (CN) 201410242468.1

(51) Int. Cl. G09G 3/36

(52) U.S. Cl. CPC G09G 3/3696

(57) ABSTRACT

The present invention discloses a gamma reference voltage generating circuit, an array substrate and a display device. The gamma reference voltage generating circuit comprises a voltage collection module, an original voltage generating module, an operation module, and an output voltage generating module, the operation module performs an operational processing on a feedback signal output from the voltage collecting module and an original gamma reference voltage signal output from the original voltage generating module to generate a new gamma reference voltage, which is then output by the output voltage generating module. The above circuit achieves the object that the gamma reference voltage is automatically adjusted with fluctuation of the common electrode voltage, keeps a balance of the voltage difference between the data voltage and the common electrode voltage when outputting signals via data lines, and avoids the greenish phenomenon caused by fluctuation of the voltage difference.

### FIELD OF THE INVENTION

The present invention relates to the field of liquid crystal display technology, and particularly to a gamma reference voltage generating circuit, an array substrate and a display device.

### BACKGROUND OF THE INVENTION

Currently, a phenomenon that a common electrode voltage (i.e., Vcom) fluctuates occurs in a thin film transistor liquid crystal display device (TFT-LCD). Specifically, a pixel voltage may have a great impact on the common electrode voltage, and moreover, the common electrode voltage may change as charging time accumulates. However, the change of the common electrode voltage may result in greenish phenomenon in a liquid crystal display screen. The greenish phenomenon of the liquid crystal display screen refers to that, when a certain picture is displayed on the liquid crystal display screen, instable common electrode voltage results in that a change of the common electrode voltage caused by a data signal cannot be canceled out, thereby leading to a rise in brightness of green pixels.

Since pixel units are charged via respective data lines, and fluctuation of the common electrode voltage becomes more severe under a certain test picture, a voltage difference between a data voltage and the common electrode voltage fluctuates and cannot keep a balance, which results in a problem in display. For example, due to the fluctuation, a charging voltage of the pixel units is unbalanced in which a direct current component is generated, which exerts an influence on polarization of liquid crystal molecules and further leads to after-image in display. Fluctuation of the common electrode voltage gives rise to non-uniformity in charging of respective sub-pixel units, which is generally reflected by overcharge of green pixels, and in this case, brightness of the green pixels increases, resulting in greenish phenomenon under the certain picture.

From the above, due to fluctuation of the common electrode voltage in the prior art, greenish phenomenon occurs in the display screen, which results in a defect in display.

### SUMMARY OF THE INVENTION

### (1) Technical Problem to be Solved

The technical problem to be solved by the present invention is how to avoid greenish phenomenon in a display screen caused by fluctuation of the common electrode voltage.

### (2) Technical Solutions

In order to solve the above technical problem, the present invention provides a gamma reference voltage generating circuit, comprising:
a voltage collection module, an original voltage generating module, an operation module, and an output voltage generating module, wherein, the operation module performs an operational processing on a feedback signal output from the voltage collecting module and an original gamma reference voltage signal output from the original voltage generating module to generate a new gamma reference voltage signal, which is then output by the output voltage generating module.

Further, the operation module may comprise an operational amplifier.

Further, the operational amplifier may be a closed-loop negative-feedback operational amplifier, and an inverting input terminal of the operational amplifier is connected to an output terminal of the operational amplifier via a feedback resistor.

Further, the feedback signal may be a voltage feedback signal.

Further, the operational processing may specifically include a superposition operation, which is performed on the voltage feedback signal and the original gamma reference voltage signal.

Further, the voltage feedback signal and the original gamma reference voltage signal may be input to a non-inverting input terminal of the operational amplifier.

Further, the output voltage generating module may output the new gamma reference voltage signal to a display substrate, and meanwhile, the voltage collecting module may receive a common electrode voltage fed back from the display substrate and extract an alternating component from the common electrode voltage to obtain the voltage feedback signal.

Further, the voltage collecting module may comprise a capacitor.

In order to solve the above technical problem, the present invention further provides an array substrate comprising the above-described gamma reference voltage generating circuit.

In order to solve the above technical problem, the present invention further provides a display device comprising the above array substrate.

### (4) Beneficial Effects

The gamma reference voltage generating circuit provided by embodiments of the present invention comprises a voltage collection module, an original voltage generating module, an operation module, and an output voltage generating module, the operation module performs an operational processing on a feedback signal output from the voltage collecting module and an original gamma reference voltage signal output from the original voltage generating module to generate a new gamma reference voltage such that the generated new gamma reference voltage is adjustable by both the original gamma reference voltage signal and the feedback signal, and then the generated new gamma reference voltage signal is output by the output voltage generating module. In the above circuit, by performing an operational processing on the original gamma reference voltage signal and the obtained feedback signal and then outputting the generated new gamma reference voltage signal to a display substrate, an effect that the gamma reference voltage is automatically adjusted with fluctuation of the common electrode voltage is achieved, and as a result, when signals are output via data lines, a voltage difference between the data voltage and the common electrode voltage is kept balanced, and the greenish phenomenon of the display panel caused by fluctuation of the voltage difference is avoided. At the same time, the present invention further provides an array substrate and a display device based on the above circuit.

### BRIEF DESCRIPTION OF THE DRAWINGS

FIG. 1 is a schematic diagram of a composition structure of a gamma reference voltage generating circuit provided by the present invention.

FIG. 2 illustrates a preferable implementation of a gamma reference voltage generating circuit provided by Embodiment 1 of the present invention.

FIG. 3 is a schematic diagram of an inverting closed-loop amplifier.

FIG. 4 is a waveform diagram illustrating changes of a gamma reference voltage and a common electrode voltage generated by the gamma reference voltage generating circuit provided by Embodiment 1 of the present invention.

### DETAILED DESCRIPTION OF THE EMBODIMENTS

Specific implementations of the present invention will be further described in detail below in conjunction with the accompanying drawings and embodiments. The following embodiments are used for explaining the present invention, rather than limiting the scope of the present invention.

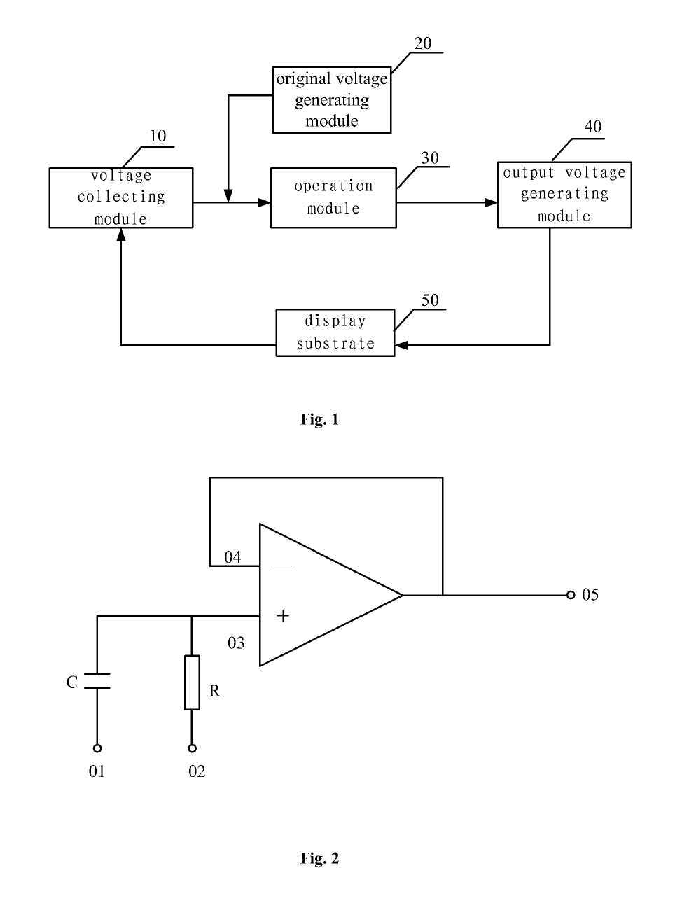

The present invention provides a gamma reference voltage generating circuit whose composition structure is shown in FIG. 1, and the gamma reference voltage generating circuit specifically comprises a voltage collection module 10, an original voltage generating module 20, an operation module 30, and an output voltage generating module 40. The operation module 30 performs an operational processing on a feedback signal output from the voltage collecting module 10 and an original gamma reference voltage signal output from the original voltage generating module 20 to generate a new gamma reference voltage signal, so that the generated new gamma reference voltage is adjustable by both the original gamma reference voltage signal and the feedback signal, and then the generated new gamma reference voltage signal is output by the output voltage generating module 40. Specifically, in the present embodiment, the output voltage generating module 40 outputs the new gamma reference voltage signal to a display substrate 50.

It should be noted that, as shown in FIG. 1, the voltage collection module 10, the operation module 30, the output voltage generating module 40 and the display substrate 50 constitute a loop structure. That is, the display substrate 50 provides a common electrode voltage to the voltage collecting module 10; the voltage collecting module 10 receives the common electrode voltage, generates a feedback signal (in the present embodiment, the feedback signal is a voltage feedback signal, i.e., a feedback signal extracted from the common electrode voltage), and sends the feedback signal to the operation module 30; the operation module 30 performs superposition operation on the feedback signal and the original gamma reference voltage signal to generate a new gamma reference voltage signal, and outputs the new gamma reference voltage signal to the output voltage generating module 40; the output voltage generating module 40 then outputs the new gamma reference voltage signal obtained through calculation to the display substrate 50. Through superposition operation by the operation module 30, the generated new gamma reference voltage signal is adjustable by both the original gamma reference voltage signal and the feedback signal, and as a result, an effect that the gamma reference voltage is adjusted with fluctuation of the common electrode voltage is achieved, so as to keep a balance of the voltage difference between the common electrode voltage and the data voltage, and avoid the greenish phenomenon.

### Embodiment 1

Based on the above circuit provided by the present invention, Embodiment 1 of the present invention provides a preferable implementation of the gamma reference voltage generating circuit, in which, as shown in FIG. 2, an operational amplifier serves as the operation module 30 in the present invention. Specifically, 01 denotes a feedback signal input terminal, 02 denotes an original gamma reference voltage signal input terminal, 03 denotes a non-inverting input terminal of the operational amplifier, 04 denotes an inverting input terminal of the operational amplifier, and 05 denotes an output terminal of the operational amplifier.

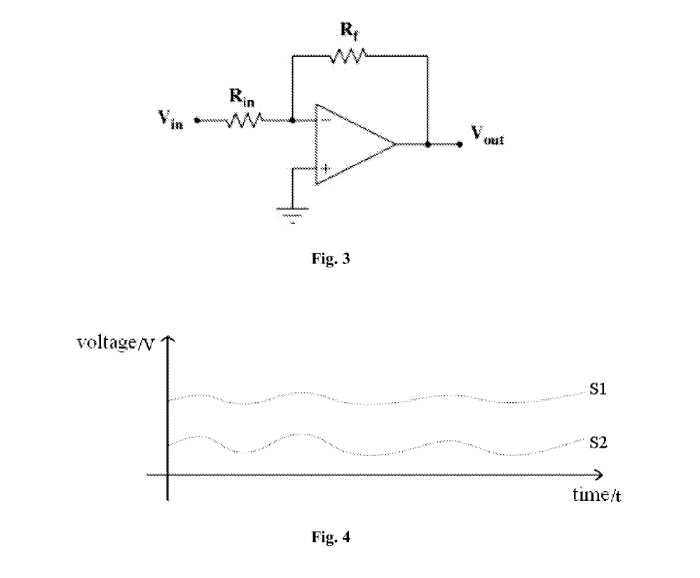

Further, the operational amplifier in this embodiment is configured to be a closed-loop negative-feedback operational amplifier, and as shown in FIG. 2, the inverting input terminal 04 (shown as “-”) of the operational amplifier is connected to the output terminal 05 of the operational amplifier via a feedback resistor (not shown in FIG. 2). Here, the closed-loop negative-feedback operational amplifier is merely one form of the operational amplifier, in which the inverting input terminal and the output terminal of the operational amplifier are connected to each other so that the operational amplifier circuit is in a negative feedback configuration, and in this case, generally, the circuit may be simply referred to as a closed-loop amplifier. Closed-loop amplifiers may be classified into inverting closed-loop amplifiers and non-inverting closed-loop amplifiers according to the terminal through which an input signal enters the amplifier. The closed-loop amplifier shown in FIG. 2 is the non-inverting closed-loop amplifier. An inverting closed-loop amplifier is as shown in FIG. 3, and assuming that the closed-loop amplifier adopts an idea operational amplifier, since an open-loop gain of the idea operational amplifier is infinite, two input terminals of the operational amplifier are connected to virtual ground, and a relational expression between an output voltage and an input voltage thereof is as follows:

Vₒᵤₜ=−(R_{f}/Rᵢₙ) * Vᵢₙ

wherein, R_{f} denotes feedback resistance, Rᵢₙ denotes input resistance, Vᵢₙ denotes input voltage, and Vₒᵤₜ denotes output voltage.

The feedback signal in this embodiment specifically is a voltage feedback signal, i.e., a feedback signal extracted from the common electrode voltage. Specifically, in this embodiment, the feedback voltage and the original gamma reference voltage are input to the non-inverting input terminal 03 (shown as “+”) of the operational amplifier; the voltage collecting module receives the common electrode voltage fed back from the display substrate, and extracts an alternating component from the common electrode voltage to obtain the feedback voltage. The voltage collecting module in this embodiment comprises a capacitor (shown as C in FIG. 2), and as shown in FIG. 2, the feedback signal input terminal 01 is connected to the non-inverting input terminal 03 of the operational amplifier via the capacitor C so as to input the feedback voltage signal. Since the direct current component in the common electrode voltage is the factor that causes both instability of the common electrode voltage and imbalance of the voltage difference between the common electrode voltage and the data voltage, the direct current component in the common electrode voltage may be filtered out and the alternating component in the common electrode voltage may be retained by using the capacitor's property of blocking direct current while allowing alternating current to pass, so as to achieve extraction from the common electrode voltage.

Moreover, it should be noted that, according to the principle of the operational amplifier, the non-inverting input terminal and the inverting input terminal have two characteristics, that is, “virtual-short” and “virtual-off”. According to these characteristics, a voltage at the output terminal is equal to that at the inverting input terminal, and is also equal to that at the non-inverting input terminal in FIG. 2. The common electrode voltage signal input from the feedback signal input terminal 01 is a composite signal comprising direct current and alternating components, the alternating component in the composite signal is obtained after the composite signal passes the capacitor C, the alternating component is superposed with the voltage obtained after the original gamma reference voltage input from the original gamma reference voltage signal input terminal 02 passes a resistor (shown as R in FIG. 2) to generate a new alternating-direct current composite gamma reference voltage, in which a waveform of the common electrode voltage is contained.

The operational processing performed after the voltage feedback signal is extracted is specifically a superposition operation, which is performed on the voltage feedback signal and the original gamma reference voltage signal. Through the superposition coupling operation, the generated new gamma reference voltage is adjustable by both the original gamma reference voltage signal and the feedback signal, and the object that the gamma reference voltage is automatically adjusted with fluctuation of the common electrode voltage is achieved.

A waveform diagram illustrating the changes of the gamma reference voltage and the common electrode voltage generated by the above circuit is shown in FIG. 4, in which S1 represents the generated gamma reference voltage signal and S2 represents the common electrode voltage signal. It can be seen from FIG. 4 that the voltage difference between the gamma reference voltage signal and the common electrode voltage signal is relatively steady and has small fluctuation, and thus the object that the gamma reference voltage is automatically adjusted with fluctuation of the common electrode voltage is achieved, the voltage difference between the data voltage and the common electrode voltage is kept balanced when outputting signals via data lines, and the greenish phenomenon caused by fluctuation of the voltage difference is avoided.

### Embodiment 2

Embodiment 2 of the present invention provides an array substrate comprising the gamma reference voltage generating circuit provided by Embodiment 1.

### Embodiment 3

Embodiment 3 of the present invention provides a display device comprising the array substrate provided by Embodiment 2.

The display device may be any product or component with a display function, such as liquid crystal panel, electronic paper, mobile phone, tablet computer, television, display, notebook computer, digital photo frame, navigator or the like.

The above implementations are merely used for explaining the present invention, rather than limiting the present invention. For those skilled in the art, various modifications and variations may be made without departing from the spirit and scope of the present invention, thus all equivalent technical solutions also belong to the scope of the present invention, and the protection scope of the present invention should be defined by the claims.

1. A gamma reference voltage generating circuit, comprising:
a voltage collection module, an original voltage generating module, an operation module, and an output voltage generating module, wherein, the operation module performs an operational processing on a feedback signal output from the voltage collecting module and an original gamma reference voltage signal output from the original voltage generating module to generate a new gamma reference voltage signal, and the new gamma reference voltage signal is then output by the output voltage generating module.

2. The gamma reference voltage generating circuit according to claim 1, wherein, the feedback signal is a voltage feedback signal.

3. The gamma reference voltage generating circuit according to claim 2, wherein, the operation module comprises an operational amplifier.

4. The gamma reference voltage generating circuit according to claim 3, wherein, the operational amplifier is a closed-loop negative-feedback operational amplifier, and an inverting input terminal of the operational amplifier is connected to an output terminal of the operational amplifier via a feedback resistor.

5. The gamma reference voltage generating circuit according to claim 2, wherein, the operational processing specifically includes a superposition operation, which is performed on the voltage feedback signal and the original gamma reference voltage signal.

6. The gamma reference voltage generating circuit according to claim 4, wherein, the voltage feedback signal and the original gamma reference voltage signal are input to a non-inverting input terminal of the operational amplifier.

7. The gamma reference voltage generating circuit according to claim 2, wherein, the output voltage generating module outputs the new gamma reference voltage signal to a display substrate, and meanwhile, the voltage collecting module receives a common electrode voltage fed back from the display substrate and extracts an alternating component from the common electrode voltage to obtain the voltage feedback signal.

8. The gamma reference voltage generating circuit according to claim 1, wherein, the voltage collecting module comprises a capacitor.

9. An array substrate, comprising a gamma reference voltage generating circuit, which comprises:
a voltage collection module, an original voltage generating module, an operation module, and an output voltage generating module, wherein, the operation module performs an operational processing on a feedback signal output from the voltage collecting module and an original gamma reference voltage signal output from the original voltage generating module to generate a new gamma reference voltage signal, and the new gamma reference voltage signal is then output by the output voltage generating module.

10. The array substrate according to claim 9, wherein, the feedback signal is a voltage feedback signal.

11. The array substrate according to claim 10, wherein, the output voltage generating module outputs the new gamma reference voltage signal to a display substrate, and meanwhile, the voltage collecting module receives a common electrode voltage fed back from the display substrate and extracts an alternating component from the common electrode voltage to obtain the voltage feedback signal.

12. The array substrate according to claim 10, wherein, the operational processing specifically includes
a superposition operation, which is performed on the voltage feedback signal and the original gamma reference voltage signal.

13. The array substrate according to claim 10, wherein, the operation module comprises an operational amplifier.

14. The array substrate according to claim 13, wherein, the operational amplifier is a closed-loop negative-feedback operational amplifier, and an inverting input terminal of the operational amplifier is connected to an output terminal of the operational amplifier via a feedback resistor.

15. The array substrate according to claim 14, wherein, the voltage feedback signal and the original gamma reference voltage signal are input to a non-inverting input terminal of the operational amplifier.

16. The array substrate according to claim 9, wherein, the voltage collecting module comprises a capacitor.

17. A display device, comprising the array substrate according to claim 9.

18. The display device according to claim 17, wherein, the feedback signal is a voltage feedback signal.

19. The display device according to claim 18, wherein, the output voltage generating module outputs the new gamma reference voltage signal to a display substrate, and meanwhile, the voltage collecting module receives a common electrode voltage fed back from the display substrate and extracts an alternating component from the common electrode voltage to obtain the voltage feedback signal.
